(19) United States
(12) Patent Application Publication
(10) Pub. No.: US 2025/0343935 A1
(43) Pub. Date: Nov. 6, 2025

(54) METHOD, APPARATUS, AND MEDIUM FOR VISUAL DATA PROCESSING

(71) Applicants: Douyin Vision Co., Ltd., Beijing (CN); Bytedance Inc., Los Angeles, CA (US)

(72) Inventors: Yaojun WU, Beijing (CN); Semih Esenlik, Los Angeles, CA (US); Meng Wang, fBeijing (CN); Zhaobin Zhang, Los Angeles, CA (US); Kai Zhang, Los Angeles, CA (US); Li Zhang, Los Angeles, CA (US)

(21) Appl. No.: 19/268,705

(22) Filed: Jul. 14, 2025

Related U.S. Application Data
(63) Continuation of application No. PCT/CN2024/072161, filed on Jan. 12, 2024.

(30) Foreign Application Priority Data
Jan. 13, 2023 (WO) PCT/CN2023/072105

(51) Int. Cl. H04N 19/436; H04N 19/13; H04N 19/184; H04N 19/196; H04N 19/70; H04N 19/91

(52) U.S. Cl. CPC H04N 19/436; H04N 19/13; H04N 19/184; H04N 19/196; H04N 19/70; H04N 19/91

(57) ABSTRACT

Embodiments of the present disclosure provide a solution for visual data processing. In the method, for a conversion between a current visual unit of visual data and a bitstream of the visual data, a plurality of threads for coding residual information of the current visual unit is determined. The conversion is performed based on the plurality of threads.

### CROSS-REFERENCE TO RELATED APPLICATIONS

This application is a continuation of International Application No. PCT/CN2024/072161, filed on Jan. 12, 2024, which claims the benefit of International Application No. PCT/CN2023/072105 filed on Jan. 13, 2023. The entire contents of these applications are hereby incorporated by reference in their entireties.

### FIELDS

Embodiments of the present disclosure relates generally to visual data processing techniques, and more particularly, to residual information coding with a plurality of threads.

### BACKGROUND

Image/video compression is an essential technique to reduce the costs of image/video transmission and storage in a lossless or lossy manner. Image/video compression techniques can be divided into two branches, the classical video coding methods and the neural-network-based video compression methods. Classical video coding schemes adopt transform-based solutions, in which researchers have exploited statistical dependency in the latent variables (e.g., wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs. Coding efficiency of image/video coding is generally expected to be further improved.

### SUMMARY

Embodiments of the present disclosure provide a solution for visual data processing.

In a first aspect, a method for visual data processing is proposed. The method comprises: determining, for a conversion between a current visual unit of visual data and a bitstream of the visual data, a plurality of threads for coding residual information of the current visual unit; and performing the conversion based on the plurality of threads. The method in accordance with the first aspect of the present disclosure coding the residual information by using a plurality of threads. In this way, the coding efficiency and/or coding effectiveness can thus be improved.

In a second aspect, an apparatus for visual data processing is proposed. The apparatus comprises a processor and a non-transitory memory with instructions thereon. The instructions upon execution by the processor, cause the processor to perform a method in accordance with the first aspect of the present disclosure.

In a third aspect, a non-transitory computer-readable storage medium is proposed. The non-transitory computer-readable storage medium stores instructions that cause a processor to perform a method in accordance with the first aspect of the present disclosure.

In a fourth aspect, another non-transitory computer-readable recording medium is proposed. The non-transitory computer-readable recording medium stores a bitstream of a video which is generated by a method performed by an apparatus for data processing. The method comprises: determining a plurality of codewords in the bitstream, a codeword being associated with at least one of: semantic element information, or latent variable information of at least one color component of a current visual unit of the visual data; and generating the bitstream based on the plurality of codewords.

In a fifth aspect, a method for storing a bitstream of a video is proposed. The method comprises: determining a plurality of codewords in the bitstream, a codeword being associated with at least one of: semantic element information, or latent variable information of at least one color component of a current visual unit of the visual data; generating the bitstream based on the plurality of codewords; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example visual data coding system, in accordance with some embodiments of the present disclosure;

FIG. 2 illustrates a typical transform coding scheme;

FIG. 3 illustrates an image from the Kodak dataset and different representations of the image;

FIG. 4 illustrates a network architecture of an autoencoder implementing the hyperprior model;

FIG. 5 illustrates a block diagram of a combined model;

FIG. 6 illustrates an encoding process of the combined model;

FIG. 7 illustrates a decoding process of the combined model;

FIG. 8 illustrates an encoding process with decouple framework;

FIG. 9 illustrates a decoding process with decouple framework;

FIG. 10 illustrates an example of one possible bitstream of the residual information;

FIG. 11 illustrates a flowchart of a method for visual data processing in accordance with embodiments of the present disclosure; and

FIG. 12 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

As used herein, the term “visual data” may refer to image data or video data. The term “visual data processing” may refer to image processing or video processing. The term “visual data coding” may refer to image coding or video coding. The term “coding visual data” may refer to “encoding visual data (for example, encoding visual data into a bitstream)” and/or “decoding visual data (for example, decoding visual data from a bitstream”.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

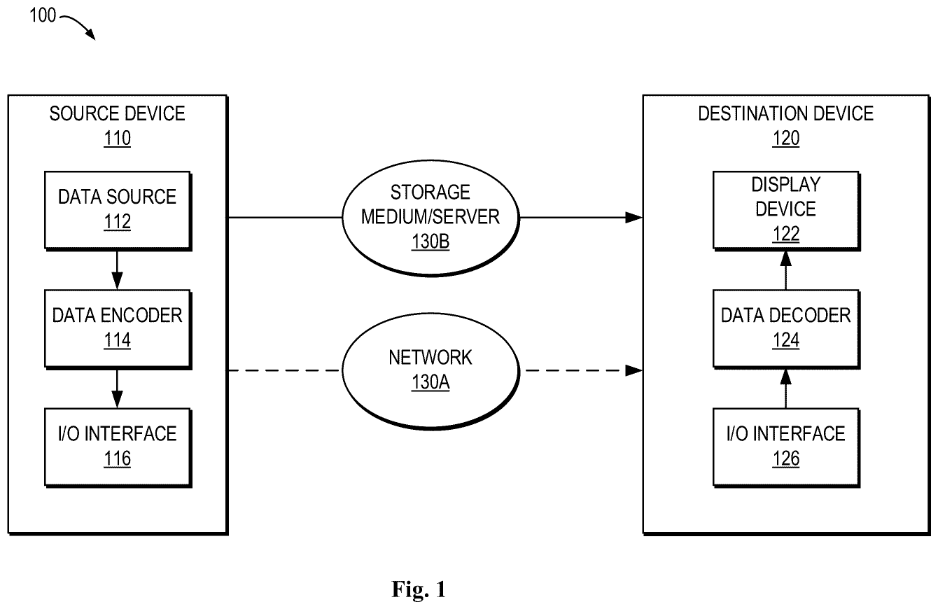

FIG. 1 is a block diagram that illustrates an example visual data coding system 100 that may utilize the techniques of this disclosure. As shown, the visual data coding system 100 may include a source device 110 and a destination device 120. The source device 110 can be also referred to as a data encoding device or a visual data encoding device, and the destination device 120 can be also referred to as a data decoding device or a visual data decoding device. In operation, the source device 110 can be configured to generate encoded visual data and the destination device 120 can be configured to decode the encoded visual data generated by the source device 110. The source device 110 may include a data source 112, a data encoder 114, and an input/output (I/O) interface 116.

The data source 112 may include a source such as a data capture device. Examples of the data capture device include, but are not limited to, an interface to receive data from a data provider, a computer graphics system for generating data, and/or a combination thereof.

The data may comprise one or more pictures of a video or one or more images. The data encoder 114 encodes the data from the data source 112 to generate a bitstream. The bitstream may include a sequence of bits that form a coded representation of the data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded data may be transmitted directly to destination device 120 via the I/O interface 116 through the network 130A. The encoded data may also be stored onto a storage medium/server 130B for access by destination device 120.

The destination device 120 may include an I/O interface 126, a data decoder 124, and a display device 122. The I/O interface 126 may include a receiver and/or a modem. The I/O interface 126 may acquire encoded data from the source device 110 or the storage medium/server 130B. The data decoder 124 may decode the encoded data. The display device 122 may display the decoded data to a user. The display device 122 may be integrated with the destination device 120, or may be external to the destination device 120 which is configured to interface with an external display device.

The data encoder 114 and the data decoder 124 may operate according to a data coding standard, such as video coding standard or still picture coding standard and other current and/or further standards.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific data codecs, the disclosed techniques are applicable to other coding technologies also. Furthermore, while some embodiments describe coding steps in detail, it will be understood that corresponding steps decoding that undo the coding will be implemented by a decoder. Furthermore, the term data processing encompasses data coding or compression, data decoding or decompression and data transcoding in which data are represented from one compressed format into another compressed format or at a different compressed bitrate.

### 1. BRIEF SUMMARY

This disclosure is related to video/image coding technologies. Specifically, it is related to neural network-based image and video compression. The ideas may be applied individually or in various combinations, to any existing video/image coding standards or non-standard video codecs like JPEG-AI, IEEE1857.11, etc. The proposed ideas may also be applicable to the future video/image coding standards or video codecs.

### 2. INTRODUCTION

The past decade has witnessed the rapid development of deep learning in a variety of areas, especially in computer vision and image processing. Inspired from the great success of deep learning technology to computer vision areas, many researchers have shifted their attention from conventional image/video compression techniques to neural image/video compression technologies. Neural network was proposed originally with the interdisciplinary research of neuroscience and mathematics. It has shown strong capabilities in the context of non-linear transform and classification. Neural network-based image/video compression technology has gained significant progress during the past half decade. It is reported that the latest neural network-based image compression algorithm achieves comparable R-D performance with Versatile Video Coding (VVC), the latest video coding standard developed by Joint Video Experts Team (JVET) with experts from MPEG and VCEG. With the performance of neural image compression continually being improved, neural network-based video compression has become an actively developing research area. However, neural network-based video coding remains in its infancy due to the inherent difficulty of the problem.

### 2.1 Image/Video Compression

Image/video compression usually refers to the computing technology that compresses image/video into binary code to facilitate storage and transmission. The binary codes may or may not support lossless reconstructing the original image/video, termed lossless compression and lossy compression. Most of the efforts are devoted to lossy compression since lossless reconstruction is not necessary in most scenarios. Usually the performance of image/video compression algorithms is evaluated from two aspects, i.e. compression ratio and reconstruction quality. Compression ratio is directly related to the number of binary codes, the less the better; Reconstruction quality is measured by comparing the reconstructed image/video with the original image/video, the higher the better.

Image/video compression techniques can be divided into two branches, the classical video coding methods and the neural-network-based video compression methods. Classical video coding schemes adopt transform-based solutions, in which researchers have exploited statistical dependency in the latent variables (e.g., DCT or wavelet coefficients) by carefully hand-engineering entropy codes modeling the dependencies in the quantized regime. Neural network-based video compression is in two flavors, neural network-based coding tools and end-to-end neural network-based video compression. The former is embedded into existing classical video codecs as coding tools and only serves as part of the framework, while the latter is a separate framework developed based on neural networks without depending on classical video codecs.

In the last three decades, a series of classical video coding standards have been developed to accommodate the increasing visual content. The international standardization organizations ISO/IEC has two expert groups namely Joint Photographic Experts Group (JPEG) and Moving Picture Experts Group (MPEG), and ITU-T also has its own Video Coding Experts Group (VCEG) which is for standardization of image/video coding technology. The influential video coding standards published by these organizations include JPEG, JPEG 2000, H.262, H.264/AVC and H.265/HEVC. After H.265/HEVC, the Joint Video Experts Team (JVET) formed by MPEG and VCEG has been working on a new video coding standard Versatile Video Coding (VVC). The first version of VVC was released in July 2020. An average of 50% bitrate reduction is reported by VVC under the same visual quality compared with HEVC.

Neural network-based image/video compression is not a new disclosure since there were a number of researchers working on neural network-based image coding. But the network architectures were relatively shallow, and the performance was not satisfactory. Benefit from the abundance of data and the support of powerful computing resources, neural network-based methods are better exploited in a variety of applications. At present, neural network-based image/video compression has shown promising improvements, confirmed its feasibility. Nevertheless, this technology is still far from mature, and a lot of challenges need to be addressed.

### 2.2 Neural Networks

Neural networks, also known as artificial neural networks (ANN), are the computational models used in machine learning technology which are usually composed of multiple processing layers and each layer is composed of multiple simple but non-linear basic computational units. One benefit of such deep networks is believed to be the capacity for processing data with multiple levels of abstraction and converting data into different kinds of representations. Note that these representations are not manually designed; instead, the deep network including the processing layers is learned from massive data using a general machine learning procedure. Deep learning eliminates the necessity of handcrafted representations, and thus is regarded useful especially for processing natively unstructured data, such as acoustic and visual signal, whilst processing such data has been a longstanding difficulty in the artificial intelligence field.

### 2.3 Neural Networks for Image Compression

Existing neural networks for image compression methods can be classified in two categories, i.e., pixel probability modeling and auto-encoder. The former one belongs to the predictive coding strategy, while the latter one is the transform-based solution. Sometimes, these two methods are combined together in literature.

### 2.3.1 Pixel Probability Modeling

According to Shannon's information theory, the optimal method for lossless coding can reach the minimal coding rate—log₂ p(x) where p(x) is the probability of symbol x. A number of lossless coding methods were developed in literature and among them arithmetic coding is believed to be among the optimal ones. Given a probability distribution p(x), arithmetic coding ensures that the coding rate to be as close as possible to its theoretical limit—log₂ p(x) without considering the rounding error. Therefore, the remaining problem is to how to determine the probability, which is however very challenging for natural image/video due to the curse of dimensionality.

Following the predictive coding strategy, one way to model p(x) is to predict pixel probabilities one by one in a raster scan order based on previous observations, where x is an image.

$$p ( x ) = p ( {x}_{1} ) p ( {x}_{2} \vert {x}_{1} ) ... p ( {x}_{i} \vert {x}_{1} , ... , {x}_{i - 1} ) ... p ( {x}_{m \times n} \vert {x}_{1} , ... , {x}_{m \times n - 1} ) \qquad ( 1 )$$

where m and n are the height and width of the image, respectively. The previous observation is also known as the context of the current pixel. When the image is large, it can be difficult to estimate the conditional probability, thereby a simplified method is to limit the range of its context.

$$p ( x ) = p ( {x}_{1} ) p ( {x}_{2} \vert {x}_{1} ) ... p ( {x}_{i} \vert {x}_{i - k} , ... , {x}_{i - 1} ) ... p ( {x}_{m \times n} \vert {x}_{m \times n - k} , ... , {x}_{m \times n - 1} ) \qquad ( 2 )$$

where k is a pre-defined constant controlling the range of the context.

It should be noted that the condition may also take the sample values of other color components into consideration. For example, when coding the RGB color component, R sample is dependent on previously coded pixels (including R/G/B samples), the current G sample may be coded according to previously coded pixels and the current R sample, while for coding the current B sample, the previously coded pixels and the current R and G samples may also be taken into consideration.

Neural networks were originally introduced for computer vision tasks and have been proven to be effective in regression and classification problems. Therefore, it has been proposed using neural networks to estimate the probability of p(x) given its context x₁, x₂, . . . , xᵢ₋₁. The pixel probability is proposed for binary images, i.e., xᵢ∈{−1, +1}. The neural autoregressive distribution estimator (NADE) is designed for pixel probability modeling, where is a feed-forward network with a single hidden layer. A similar work is presented, where the feed-forward network also has connections skipping the hidden layer, and the parameters are also shared. These approaches perform experiments on the binarized MNIST dataset. NADE is extended to a real-valued model RNADE, where the probability p(xᵢ|x₁, . . . , xᵢ₋₁) is derived with a mixture of Gaussians. Their feed-forward network also has a single hidden layer, but the hidden layer is with rescaling to avoid saturation and uses rectified linear unit (ReLU) instead of sigmoid. NADE and RNADE are improved by using reorganizing the order of the pixels and with deeper neural networks.

Most of the above methods directly model the probability distribution in the pixel domain. Some researchers also attempt to model the probability distribution as a conditional one upon explicit or latent representations. That being said, it may estimate

$$p ( x \vert h ) = {\prod }_{i = 1}^{m \times n} p ( {x}_{i} \vert {x}_{1} , ... , {x}_{i - 1} , h ) \qquad ( 3 )$$

where h is the additional condition and p(x)=p(h)p(x|h), meaning the modeling is split into an unconditional one and a conditional one. The additional condition can be image label information or high-level representations.

### 2.3.2 Auto-Encoder

Auto-encoder has been proposed. The method is trained for dimensionality reduction and consists of two parts: encoding and decoding. The encoding part converts the high-dimension input signal to low-dimension representations, typically with reduced spatial size but a greater number of channels. The decoding part attempts to recover the high-dimension input from the low-dimension representation. Auto-encoder enables automated learning of representations and eliminates the need of hand-crafted features, which is also believed to be one of the most important advantages of neural networks.

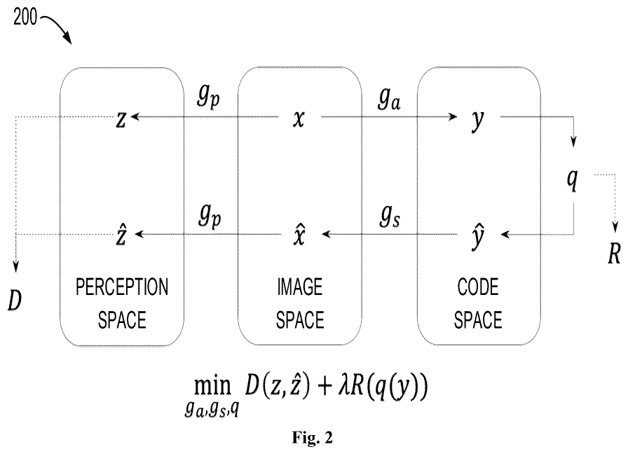

FIG. 2 is a schematic diagram illustrating an example transform coding scheme 200. The original image x is transformed by the analysis network gₐ to achieve the latent representation y. The latent representation y is quantized (q) and compressed into bits. The number of bits R is used to measure the coding rate. The quantized latent representation ŷ is then inversely transformed by a synthesis network gₛ to obtain the reconstructed image \hat{x}. The distortion (D) is calculated in a perceptual space by transforming x and \hat{x} with the function gₚ, resulting in z and \hat{z}, which are compared to obtain D.

It is intuitive to apply auto-encoder network to lossy image compression. It only needs to encode the learned latent representation from the well-trained neural networks. However, it is not trivial to adapt auto-encoder to image compression since the original auto-encoder is not optimized for compression thereby not efficient by directly using a trained auto-encoder. In addition, there exist other major challenges: First, the low-dimension representation should be quantized before being encoded, but the quantization is not differentiable, which is required in backpropagation while training the neural networks. Second, the objective under compression scenario is different since both the distortion and the rate need to be take into consideration. Estimating the rate is challenging. Third, a practical image coding scheme needs to support variable rate, scalability, encoding/decoding speed, interoperability. In response to these challenges, a number of researchers have been actively contributing to this area.

The prototype auto-encoder for image compression is in FIG. 2, which can be regarded as a transform coding strategy. The original image x is transformed with the analysis network y=gₐ(x), where y is the latent representation which will be quantized and coded. The synthesis network will inversely transform the quantized latent representation ŷ back to obtain the reconstructed image \hat{x}=gₛ(y). The framework is trained with the rate-distortion loss function, i.e., [symbol] =D+λR, where D is the distortion between x and \hat{x}, R is the rate calculated or estimated from the quantized representation ŷ, and λ is the Lagrange multiplier. It should be noted that D can be calculated in either pixel domain or perceptual domain. All existing research works follow this prototype and the difference might only be the network structure or loss function.

### 2.3.3 Hyper Prior Model

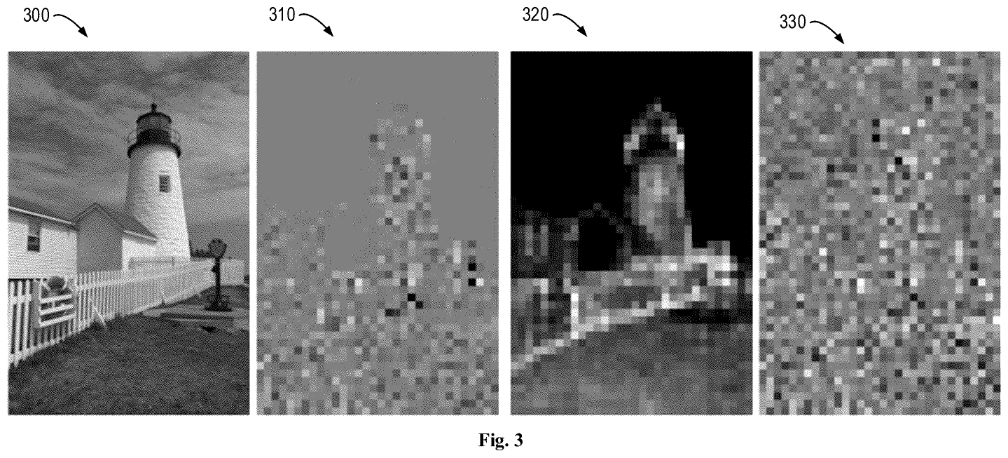

FIG. 3 illustrates example latent representations of an image, including an image 300 from the Kodak dataset, a visualization of the latent 310 representation y of the image 300, a standard deviations σ 320 of the latent 310, and latents y 330 after a hyper prior network is introduced. A hyper prior network includes a hyper encoder and decoder.

In the transform coding approach to image compression, as shown in FIG. 2, the encoder subnetwork (section 2.3.2) transforms the image vector x using a parametric analysis transform gₐ(x, Ø_{g}) into a latent representation y, which is then quantized to form ŷ. Because ŷ is discrete-valued, ŷ can be losslessly compressed using entropy coding techniques such as arithmetic coding and transmitted as a sequence of bits.

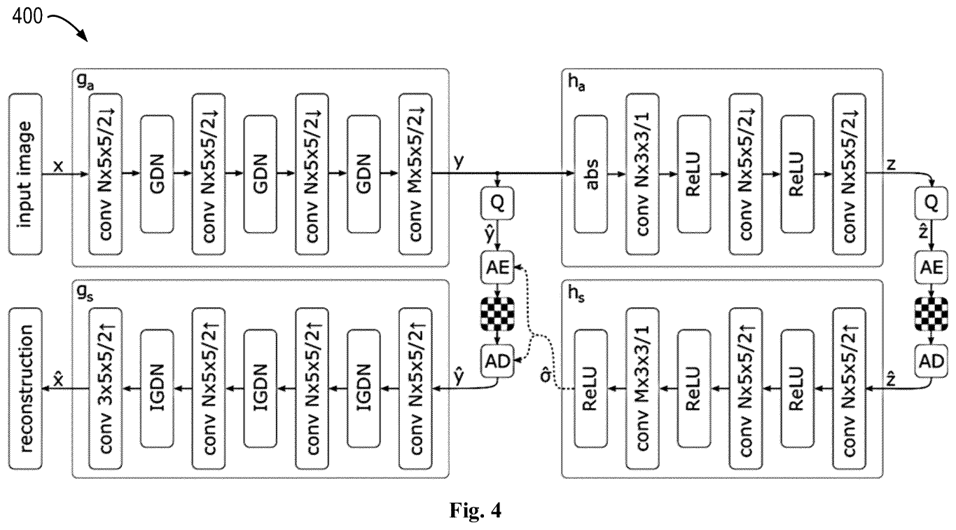

As evident from the latent 310 and the standard deviations σ 320 of FIG. 3, there are significant spatial dependencies among the elements of ŷ. Notably, their scales (standard deviations σ 320) appear to be coupled spatially. An additional set of random variables \hat{z} may be introduced to capture the spatial dependencies and to further reduce the redundancies. In this case the image compression network is depicted in FIG. 4.

FIG. 4 is a schematic diagram 400 illustrating an example network architecture of an autoencoder implementing a hyperprior model. The upper side shows an image autoencoder network, and the lower side corresponds to the hyperprior subnetwork. The analysis and synthesis transforms are denoted as gₐ and gₐ. Q represents quantization, and AE, AD represent arithmetic encoder and arithmetic decoder, respectively. The hyperprior model includes two subnetworks, hyper encoder (denoted with hₐ) and hyper decoder (denoted with hₛ). The hyper prior model generates a quantized hyper latent (\hat{z}) which comprises information related to the probability distribution of the samples of the quantized latent ŷ. \hat{z} is included in the bitstream and transmitted to the receiver (decoder) along with ŷ.

In schematic diagram 400, the upper side of the models is the encoder gₐ and decoder gₛ as discussed above. The lower side is the additional hyper encoder hₐ and hyper decoder hₛ networks that are used to obtain \hat{z}. In this architecture the encoder subjects the input image x to gₐ, yielding the responses y with spatially varying standard deviations. The responses y are fed into hₐ, summarizing the distribution of standard deviations in z. z is then quantized (\hat{z}), compressed, and transmitted as side information. The encoder then uses the quantized vector \hat{z} to estimate σ, the spatial distribution of standard deviations, and uses σ to compress and transmit the quantized image representation ŷ. The decoder first recovers 2 from the compressed signal. The decoder then uses hₛ to obtain, which provides the decoder with the correct probability estimates to successfully recover ŷ as well. The decoder then feeds ŷ into gₛ to obtain the reconstructed image.

When the hyper encoder and hyper decoder are added to the image compression network, the spatial redundancies of the quantized latent ŷ are reduced. The latents y 330 in FIG. 3 correspond to the quantized latent when the hyper encoder/decoder are used. Compared to the standard deviations σ 320, the spatial redundancies are significantly reduced as the samples of the quantized latent are less correlated.

### 2.3.4 Context Model

Although the hyper prior model improves the modelling of the probability distribution of the quantized latent ŷ, additional improvement can be obtained by utilizing an autoregressive model that predicts quantized latents from their causal context (Context Model).

The term auto-regressive means that the output of a process is later used as input to it. For example the context model subnetwork generates one sample of a latent, which is later used as input to obtain the next sample.

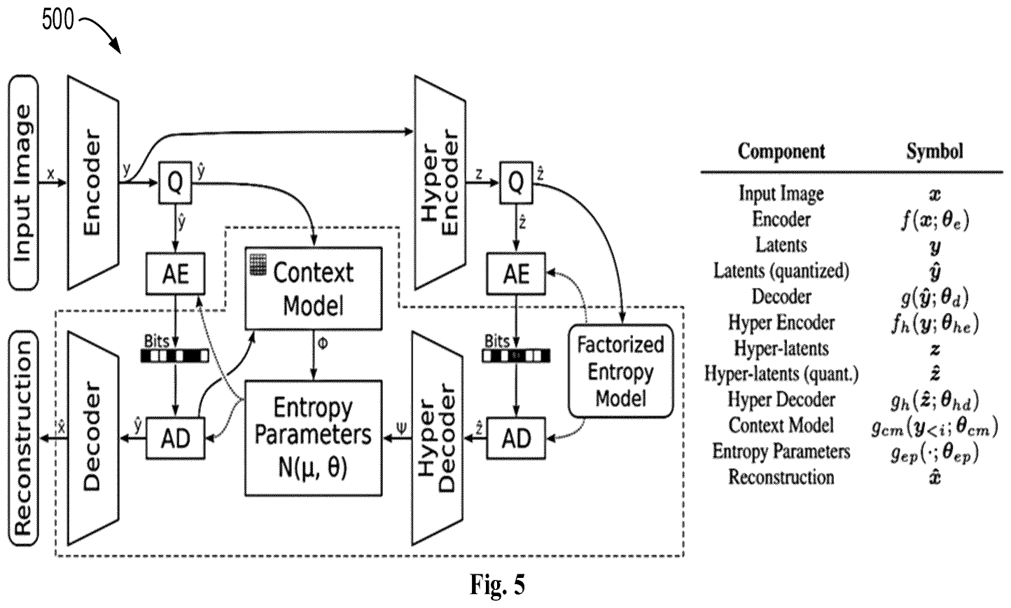

FIG. 5 is a schematic diagram 500 illustrating an example combined model configured to jointly optimize a context model along with a hyperprior and the autoencoder. The combined model jointly optimizes an autoregressive component that estimates the probability distributions of latents from their causal context (Context Model) along with a hyperprior and the underlying autoencoder. Real-valued latent representations are quantized (Q) to create quantized latents (ŷ) and quantized hyper-latents (\hat{z}), which are compressed into a bitstream using an arithmetic encoder (AE) and decompressed by an arithmetic decoder (AD). The dashed region corresponds to the components that are executed by the receiver (e.g, a decoder) to recover an image from a compressed bitstream.

An example system utilizes a joint architecture where both a hyperprior model subnetwork (hyper encoder and hyper decoder) and a context model subnetwork are utilized. The hyperprior and the context model are combined to learn a probabilistic model over quantized latents ŷ, which is then used for entropy coding. As depicted in schematic diagram 500, the outputs of the context subnetwork and hyper decoder subnetwork are combined by the subnetwork called Entropy Parameters, which generates the mean μ and scale (or variance) σ parameters for a Gaussian probability model. The gaussian probability model is then used to encode the samples of the quantized latents into bitstream with the help of the arithmetic encoder (AE) module. In the decoder the gaussian probability model is utilized to obtain the quantized latents ŷ from the bitstream by arithmetic decoder (AD) module.

In an example, the latent samples are modeled as gaussian distribution or gaussian mixture models (not limited to). In the example according to the schematic diagram 500, the context model and hyper prior are jointly used to estimate the probability distribution of the latent samples. Since a gaussian distribution can be defined by a mean and a variance (aka sigma or scale), the joint model is used to estimate the mean and variance (denoted as μ and σ).

### 2.3.5 Gained Variational Autoencoders (G-VAE)

Typically, neural network-based image/video compression methodologies need to train multiple models to adapt to different rates. Gained variational autoencoders (G-VAE) is the variational autoencoder with a pair of gain units, which is designed to achieve continuously variable rate adaptation using a single model. It comprises of a pair of gain units, which are typically inserted to the output of encoder and input of decoder. The output of the encoder is defined as the latent representation y∈R^{c*h*w}, where c, h, w represent the number of channels, the height and width of the latent representation. Each channel of the latent representation is denoted as y₍ᵢ₎∈R^{h*w}, where i=0, 1, . . . , c−1. A pair of gain units include a gain matrix M∈R^{c*n} and an inverse gain matrix, where n is the number of gain vectors. The gain vector can be denoted as mₛ={αₛ₍₀₎, αₛ₍₁₎, . . . , α_{s(c-1)}}, αₛ₍ᵢ₎∈R where s denotes the index of the gain vectors in the gain matrix.

The motivation of gain matrix is similar to the quantization table in JPEG by controlling the quantization loss based on the characteristics of different channels. To apply the gain matrix to the latent representation, each channel is multiplied with the corresponding value in a gain vector.

$${\overline{y}}_{s} = y ⊙ {m}_{s} .$$

Where ⊙ is channel-wise multiplication, i.e., y̅ₛ₍ᵢ₎=y₍ᵢ₎×αₛ₍ᵢ₎, and αₛ₍ᵢ₎ is the i-th gain value in the gain vector mₛ. The inverse gain matrix used at the decoder side can be denoted as M′ΣR^{c*n}, which consists of n inverse gain vectors, i.e., M′={δₛ₍₀₎, δₛ₍₁₎, . . . , δ_{s(c-1)}}, δₛ₍ᵢ₎∈R. The inverse gain process is expressed as

$${{y}^{′}}_{s} = \hat{y} ⊙ {m}_{s}^{′}$$

where ŷ is the decoded quantized latent representation and y′ₛ is the inversely gained quantized latent representation, which will be fed into the synthesis network.

To achieve continuous variable rate adjustment, interpolation is used between vectors. Given two pairs of gain vectors {mₜ,

$${m}_{t}^{′}$$

} and {mᵣ,

$${m}_{r}^{′}$$

}, the interpolated gain vector can be obtained via the following equations.

$${m}_{v} = [ {( {m}_{r} )}^{l} \cdot {( {m}_{t} )}^{1 - l} ]$$

$${m}_{v}^{′} = [ {( {m}_{r}^{′} )}^{l} \cdot {( {m}_{t}^{′} )}^{1 - l} ]$$

where l∈R is an interpolation coefficient, which controls the corresponding bit rate of the generated gain vector pair. Since l is a real number, an arbitrary bit rate between the given two gain vector pairs can be achieved.

### 2.5.6 The Encoding Process of the Latent Information Using Joint Auto-Regressive Hyper Prior Model

The design in FIG. 5. corresponds an example combined compression method. In this section and the next, the encoding and decoding processes are described separately.

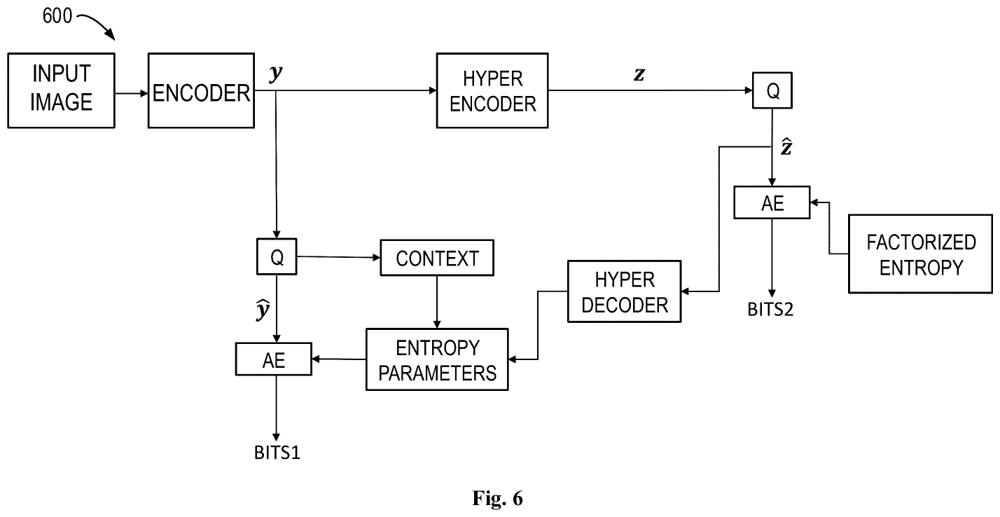

FIG. 6 illustrates an example encoding process 600. The input image is first processed with an encoder subnetwork. The encoder transforms the input image into a transformed representation called latent, denoted by y. y is then input to a quantizer block, denoted by Q, to obtain the quantized latent (ŷ). ŷ is then converted to a bitstream (bits1) using an arithmetic encoding module (denoted AE). The arithmetic encoding block converts each sample of the ŷ into a bitstream (bits1) one by one, in a sequential order.

The modules hyper encoder, context, hyper decoder, and entropy parameters subnetworks are used to estimate the probability distributions of the samples of the quantized latent ŷ. the latent y is input to hyper encoder, which outputs the hyper latent (denoted by z). The hyper latent is then quantized (\hat{z}) and a second bitstream (bits2) is generated using arithmetic encoding (AE) module. The factorized entropy module generates the probability distribution, that is used to encode the quantized hyper latent into bitstream. The quantized hyper latent includes information about the probability distribution of the quantized latent (ŷ).

The Entropy Parameters subnetwork generates the probability distribution estimations, that are used to encode the quantized latent ŷ. The information that is generated by the Entropy Parameters typically include a mean μ and scale (or variance) σ parameters, that are together used to obtain a gaussian probability distribution. A gaussian distribution of a random variable x is defined as

$$f ( x ) = \frac{1}{σ \sqrt{2 π}} {e}^{- \frac{1}{2} {( \frac{x - μ}{σ} )}^{2}}$$

wherein the parameter μ is the mean or expectation of the distribution (and also its median and mode), while the parameter σ is its standard deviation (or variance, or scale). In order to define a gaussian distribution, the mean and the variance need to be determined. The entropy parameters module are used to estimate the mean and the variance values.

The subnetwork hyper decoder generates part of the information that is used by the entropy parameters subnetwork, the other part of the information is generated by the autoregressive module called context module. The context module generates information about the probability distribution of a sample of the quantized latent, using the samples that are already encoded by the arithmetic encoding (AE) module. The quantized latent ŷ is typically a matrix composed of many samples. The samples can be indicated using indices, such as ŷ[i,j,k] or ŷ[i,j] depending on the dimensions of the matrix ŷ. The samples ŷ[i,j] are encoded by AE one by one, typically using a raster scan order. In a raster scan order the rows of a matrix are processed from top to bottom, wherein the samples in a row are processed from left to right. In such a scenario (wherein the raster scan order is used by the AE to encode the samples into bitstream), the context module generates the information pertaining to a sample ŷ[i,j], using the samples encoded before, in raster scan order. The information generated by the context module and the hyper decoder are combined by the entropy parameters module to generate the probability distributions that are used to encode the quantized latent ŷ into bitstream (bits1).

Finally the first and the second bitstream are transmitted to the decoder as result of the encoding process.

It is noted that the other names can be used for the modules described above.

In the above description, the all of the elements in FIG. 6 are collectively called encoder. The analysis transform that converts the input image into latent representation is also called an encoder (or auto-encoder).

### 2.3.7 The Decoding Process of the Latent Information Using Joint Auto-Regressive Hyper Prior Model

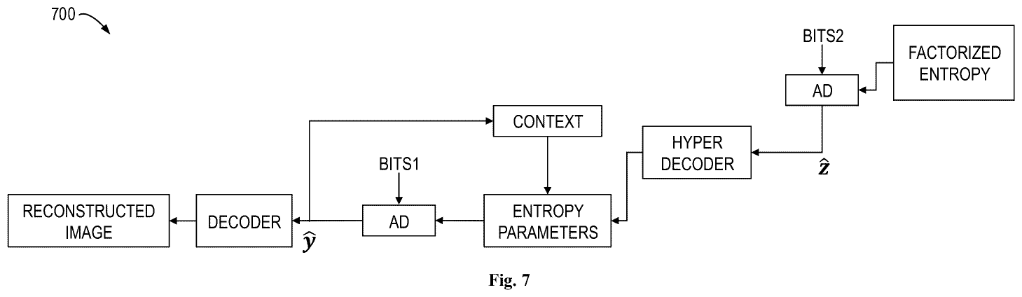

FIG. 7 illustrates an example decoding process 700. FIG. 7 depicts a decoding process separately. In the decoding process, the decoder first receives the first bitstream (bits1) and the second bitstream (bits2) that are generated by a corresponding encoder. The bits2 is first decoded by the arithmetic decoding (AD) module by utilizing the probability distributions generated by the factorized entropy subnetwork. The factorized entropy module typically generates the probability distributions using a predetermined template, for example using predetermined mean and variance values in the case of gaussian distribution. The output of the arithmetic decoding process of the bits2 is \hat{z}, which is the quantized hyper latent. The AD process reverts to AE process that was applied in the encoder. The processes of AE and AD are lossless, meaning that the quantized hyper latent \hat{z} that was generated by the encoder can be reconstructed at the decoder without any change. After obtaining of \hat{z}, it is processed by the hyper decoder, whose output is fed to entropy parameters module. The three subnetworks, context, hyper decoder and entropy parameters that are employed in the decoder are identical to the ones in the encoder. Therefore the exact same probability distributions can be obtained in the decoder (as in encoder), which is essential for reconstructing the quantized latent ŷ without any loss. As a result, the identical version of the quantized latent ŷ that was obtained in the encoder can be obtained in the decoder. After the probability distributions (e.g. the mean and variance parameters) are obtained by the entropy parameters subnetwork, the arithmetic decoding module decodes the samples of the quantized latent one by one from the bitstream bits1. From a practical standpoint, autoregressive model (the context model) is inherently serial, and therefore cannot be sped up using techniques such as parallelization.

Finally the fully reconstructed quantized latent ŷ is input to the synthesis transform (denoted as decoder in FIG. 7) module to obtain the reconstructed image.

In the above description, the all of the elements in FIG. 7 are collectively called decoder. The synthesis transform that converts the quantized latent into reconstructed image is also called a decoder (or auto-decoder).

### 2.3.8 Encoding Process with Decouple Framework

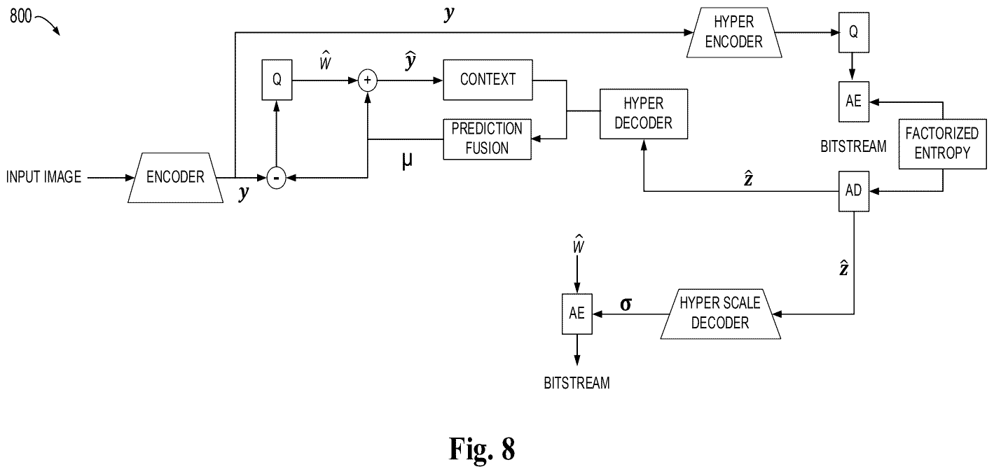

FIG. 8 depicts the encoding process with decouple framework 800.

The encoding operation is performed as follows:
1. First, the following steps are performed in a loop until all elements of quantized residual latent ŵ are obtained:
   a. A first subnetwork is used to estimate a mean value parameter of the latent y, using the already obtained samples of quantized latent ŷ.
   b. The mean value is subtracted from y to obtain the residual w, which is quantized to obtain quantized residual latent ŵ.
   c. ŵ is added to the mean value added to obtain the quantized latent ŷ.
2. Secondly, a second subnetwork is used to estimate probability parameters (e.g., variance) using a quantized hyper latent \hat{z}.
3. The probability parameters are used by the entropy encoder module to encode elements of the quantized residual latent into the bitstream.

### 2.3.9 Decoding Process with Decouple Framework

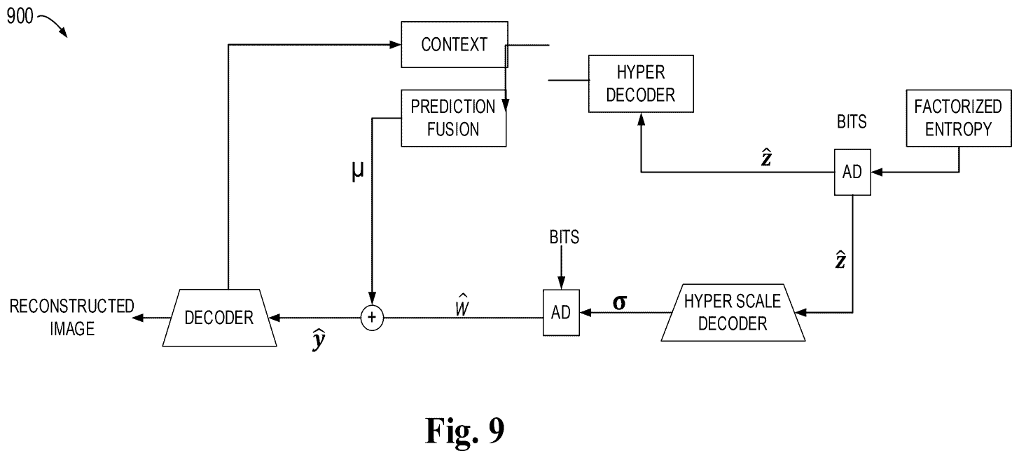

FIG. 9 depicts the decoding process with decouple framework 900.

The decoding operation is performed as follows:
1. Firstly, a second subnetwork is used to estimate probability parameters using a quantized hyper latent (\hat{z}).
2. The probability parameters (e.g. variance) generated by the second network is used to generate a quantized residual latent (denoted ŵ in FIG. 9) by performing the arithmetic decoding process. The arithmetic decoder decodes the received bitstream based on the said probability parameters and generates the ŵ.
3. The following steps are performed in a loop until all elements of ŷ are obtained:
   a. A first subnetwork is used to estimate a mean value parameter of a quantized latent (ŷ), using the already obtained samples of ŷ.
   b. The quantized residual latent ŵ and the mean value are used to obtain the next element of ŷ.
4. After all of the samples of ŷ are obtained, a synthesis transform, such as the decoder module in FIG. 9 can be applied to obtain the reconstructed image.

### 2.4 Neural Networks for Video Compression

Similar to conventional video coding technologies, neural image compression serves as the foundation of intra compression in neural network-based video compression, thus development of neural network-based video compression technology comes later than neural network-based image compression but needs far more efforts to solve the challenges due to its complexity. Starting from 2017, a few researchers have been working on neural network-based video compression schemes. Compared with image compression, video compression needs efficient methods to remove inter-picture redundancy. Inter-picture prediction is then a crucial step in these works. Motion estimation and compensation is widely adopted but is not implemented by trained neural networks until recently.

Studies on neural network-based video compression can be divided into two categories according to the targeted scenarios: random access and the low-latency. In random access case, it requires the decoding can be started from any point of the sequence, typically divides the entire sequence into multiple individual segments and each segment can be decoded independently. In low-latency case, it aims at reducing decoding time thereby usually merely temporally previous frames can be used as reference frames to decode subsequent frames.

### 2.5 Preliminaries

Almost all the natural image/video is in digital format. A grayscale digital image can be represented by x∈ [symbol] ^{m×n}, where [symbol] is the set of values of a pixel, m is the image height and n is the image width. For example, [symbol] ={0, 1, 2, . . . , 255} is a common setting and in this case | [symbol] |=256=2⁸, thus the pixel can be represented by an 8-bit integer. An uncompressed grayscale digital image has 8 bits-per-pixel (bpp), while compressed bits are definitely less.

A color image is typically represented in multiple channels to record the color information. For example, in the RGB color space an image can be denoted by x∈ [symbol] ^{m×n×3} with three separate channels storing Red, Green and Blue information. Similar to the 8-bit grayscale image, an uncompressed 8-bit RGB image has 24 bpp. Digital images/videos can be represented in different color spaces. The neural network-based video compression schemes are mostly developed in RGB color space while the traditional codecs typically use YUV color space to represent the video sequences. In YUV color space, an image is decomposed into three channels, namely Y, Cb and Cr, where Y is the luminance component and Cb/Cr are the chroma components. The benefits come from that Cb and Cr are typically down sampled to achieve pre-compression since human vision system is less sensitive to chroma components.

A color video sequence is composed of multiple color images, called frames, to record scenes at different timestamps. For example, in the RGB color space, a color video can be denoted by X={x₀, x₁, . . . , xₜ, . . . , x_{T-1}} where T is the number of frames in this video sequence, x∈ [symbol] ^{m×n}. If m=1080, n=1920, | [symbol] |=28, and the video has 50 frames-per-second (fps), then the data rate of this uncompressed video is 1920×1080×8×3×50=2,488,320,000 bits-per-second (bps), about 2.32 Gbps, which needs a lot storage thereby definitely needs to be compressed before transmission over the internet.

Usually the lossless methods can achieve compression ratio of about 1.5 to 3 for natural images, which is clearly below requirement. Therefore, lossy compression is developed to achieve further compression ratio, but at the cost of incurred distortion. The distortion can be measured by calculating the average squared difference between the original image and the reconstructed image, i.e., mean-squared-error (MSE). For a grayscale image, MSE can be calculated with the following equation.

$$MSE = \frac{{‖ x - \hat{x} ‖}^{2}}{m \times n} \qquad ( 4 )$$

Accordingly, the quality of the reconstructed image compared with the original image can be measured by peak signal-to-noise ratio (PSNR):

$$PSNR = 10 \times {log}_{10} \frac{{( max ( 𝔻 ) )}^{2}}{MSE} \qquad ( 5 )$$

where max( [symbol] ) is the maximal value in [symbol] , e.g., 255 for 8-bit grayscale images. There are other quality evaluation metrics such as structural similarity (SSIM) and multi-scale SSIM (MS-SSIM).

To compare different lossless compression schemes, it is sufficient to compare either the compression ratio given the resulting rate or vice versa. However, to compare different lossy compression methods, it has to take into account both the rate and reconstructed quality. For example, to calculate the relative rates at several different quality levels, and then to average the rates, is a commonly adopted method; the average relative rate is known as Bjontegaard's delta-rate (BD-rate). There are other important aspects to evaluate image/video coding schemes, including encoding/decoding complexity, scalability, robustness, and so on.

### 3 PROBLEMS

The context adaptive binary arithmetic coding (CABAC) utilizes context modeling to build a probabilistic model thereby it needs dependence of the nearby symbols during the coding. In contrast, the learned image compression with decoupled architecture disentangles the context modeling and the probability prediction process. The residual information (e.g., quantized residual latent ŵ and corresponding quantized hyperprior information \hat{z}) thus can be decoded independently from the context modeling process. The decoupled architecture accelerates the decoding process. However, all symbols of the residual information are coded in a sequential manner, which has the following drawbacks. First, all symbols have to be decoded even only a certain part of the residual information is needed in some cases. Second, without support of parallel coding, sequential coding leads to increased decoding time.

### 4 DETAILED SOLUTIONS

The detailed embodiments below should be considered as examples to explain general concepts. These embodiments should not be interpreted in a narrow way. Furthermore, these embodiments can be combined in any manner.

### 4.1 Core of the Disclosure

According to the disclosure, multi-thread will be utilized when coding residual information, multiple codewords might be used to compress different symbols through arithmetic coding in a parallel way. And then they are combined together to form the bitstream of the whole residual information. Moreover, to indicate the location of each codeword in the decoding process, additional overhead will be stored in the bitstream with certain bitstream structure.

### 4.2 Details of Embodiments

1. It is proposed that the encoding process of the residual information might follow the steps below:
   a. Based on the network structure, obtain quantized residual latent ŵ and corresponding quantized hyperprior information \hat{z}.
   b. Obtaining probability distribution of the ŵ and \hat{z}.
   c. Determine the maximum number of the threads that utilized in entropy coding.
   d. Based on the number of the threads, divide ŵ into N groups.
   e. For each group, create a thread to finish the arithmetic encoding, and generate codewords.
   f. Combine all codewords by concatenation.
   g. Write number of the threads and the detailed location of each codewords in the bitstream.
In one example the maximum number of the threads is determined by the profile.
In one example, the maximum number of the threads is fixed parameters (i.e., 8/16/32).
In one example, the maximum number of the threads is defined in the config file.
In one example, the maximum number of the threads is dependent on the number of slices/tiles/units.
In one example, the maximum number of the threads is dependent on the resolution of the processing units.
In one example, besides ŵ, hyperprior information \hat{z} will be divided into N groups.
   In one example, the grouped ŵ and \hat{z} will be encoded independently with arithmetic coding to form their own codewords.
   In one example, the grouped ŵ and the corresponding \hat{z} will be encoded together in the same codeword using the arithmetic coder.
In one example, ŵ will be divided in spatial domain.
In one example, ŵ will be divided in channel domain.
In one example, ŵ will be flattened into 1 dimension vector, and then evenly split into N parts.
   In one example, the flatten operation is firstly scan the symbol in channel dimension, and then scan spatial domain through zig-zag scan order.
   In one example, the flatten operation is firstly scan the symbol in spatial domain through zig-zag scan order, and then scan through channel dimension.
In one example, the location syntax elements might be written at the beginning of the bitstream.
In one example, the location syntax elements might be written at the beginning of each codewords.
2. It is proposed that the decoding process of the residual information might follow the steps below:
   a. Read the number of the maximum number of the thread from the bitstream.
   b. Based on the maximum number of the thread and the device condition, determine the actual thread number that might be utilized in the decoding process.
   c. Based on the number of the thread, read the location of the bitstream.
   d. Obtaining the probability of the \hat{z}, and decode \hat{z} through arithmetic coding.
   e. Based on the \hat{z}, calculated the probability of the ŵ, and decode ŵ in parallel.
   f. Reconstruct image based on the decoded latent variables.
In one example, the actual number of the thread can be 1, in this case, codewords might be decoded in a sequential way.
In one example, the actual number of the threads can be larger than 1. The codewords might be decoded in a partial parallel way. The parallel schemes such as the pending intervals may be indicated in the bitstream and then applied to the partial parallel decoding.
3. It is proposed that additional byte alignment might be performed at the end of at least one of the codewords, i.e. if the codeword is not a multiple of 8 bits, stuffing bits might be used to make the length of the codeword multiple of 8 bits. In one example codeword byte alignment might be applied at the end of all codewords.
4. It is proposed that to obtain the location of each codeword in the bitstream, one or multiple bytes will remain at the beginning of the bitstream.
   In one example, the relative offset from the initial position will be used to locate the starting position for each part.
   In one example, the size of each part might be used to locate the position of each codeword.
   In one example, 1/2/4/8/16 bytes might be used to locate the position of one codeword.
   In one example, to record the location data, big-endian coding will be utilized.
5. It is proposed that to obtain the location of each codeword in the bitstream, length of the codeword might be utilized, one or multiple bytes will remain at the beginning of each codeword.
6. It is proposed that entropy coding might be used when coding maximum number of the thread and location of the bitstream.
   In one example, some syntax elements may be coded through arithmetic coding.
      In one example, the uniform distribution might be utilized as the probability distribution of the coded symbol.
      In one example, probability distribution might be calculated through context-adaptive manner.
   In one example, some syntax elements might be coded through fixed-pattern bit string.
   In one example, some syntax elements might be coded through exp-Golomb coding.
   In one example, some syntax elements might be directly coded through unsigned/singed integer.
7. It is proposed that codeword termination might be performed at the end of at least one of the codewords.
   In one example codeword termination might be applied at the end of all codewords.

### 4.3 Benefit of Embodiments

According to embodiments of the present disclosure, the bitstream of the residual information is split into serval parts, and the coding of the residual information is processed in a parallel manner. With the support of multi-threaded decoding, the speed of learned codec can be further improved.

### 5 EMBODIMENTS

### 1. Decoder:

An image or video decoding method, comprising a neural subnetwork, that comprises the ordered steps of:
a. Read the number of the maximum number of the thread from the bitstream.
b. Based on the maximum number of threads and the device condition, determine the actual thread number that might be utilized in the decoding process.
c. Based on the number of the thread, read the location of the bitstream.
d. Obtaining the probability of the \hat{z}, and decode \hat{z} through arithmetic coding.
e. Based on the \hat{z}, calculated the probability of the ŵ, and decode ŵ in parallel.
f. Reconstruct image based on the decoded latent variables.

### 2. Example of One Possible Bitstream of the Residual Information.

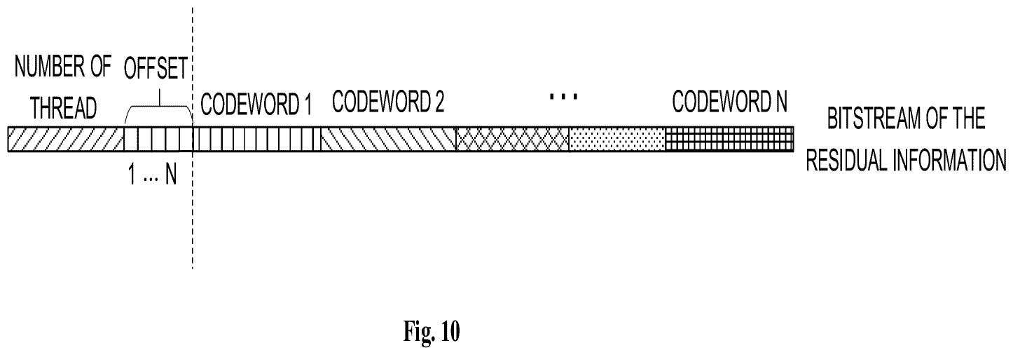

Example of one possible bitstream of the residual information is shown in FIG. 10.

In FIG. 10, the number of the codeword is firstly stored at the beginning of the residual bitstream. Then based on the number of the thread, N offset is stored following the num of the thread syntax elements. After the offset, codewords is combined through concatenate.

More details will be further discussed below. FIG. 11 illustrates a flowchart of a method 1100 for visual data processing in accordance with embodiments of the present disclosure. The method 1100 is implemented for a conversion between a current visual unit of visual data and a bitstream of the visual data. As used herein, the term “visual data” may refer to an image, or video or other visual information or data.

At block 1110, a plurality of threads for coding residual information of the current visual unit is determined. At block 1120, the conversion is performed based on the plurality of threads. For example, the conversion may be performed by coding the residual information using the plurality of threads.

The method 1100 enables coding the residual information with a plurality of threads. In this way, the coding efficiency and/or coding effectiveness can be improved.

In some embodiments, a plurality of codewords in the bitstream comprises a plurality of symbols by arithmetic coding in parallel, the residual information being included in the plurality of codewords. That is, multiple codewords may be used to compress different symbols through arithmetic coding in a parallel way. These codewords are combined together to form the bitstream of the whole residual information. The term “codeword” herein may represent a bitstream unit or bitstream segment which includes or stores at least one syntax element or information. A codeword may be separated from another codeword. As used herein, a “codeword” may be referred to as a “segment in the bitstream”, “a part in the bitstream”, “bitstream segment” or “a unit in the bitstream”. FIG. 10 illustrates several codewords in the bitstream.

In some embodiments, location information of the plurality of codewords is included in the bitstream. By way of example, the location information is included in at least one byte at a beginning of the bitstream. For example, the at least one byte may be: a byte, two bytes, 4 bytes, 8 bytes or 16 bytes.

In other words, to indicate the location of each codeword in the decoding process, additional overhead will be stored in the bitstream with certain bitstream structure.

In some embodiments, the location information comprises a relative offset of a codeword from an initial position in the bitstream, a starting position of the codeword is determined based on the relative offset.

In some embodiments, the location information comprises a size of a codeword, a position of the codeword being determined based on the size.

In some embodiments, the location information is coded by bit-endian coding.

In some embodiments, a plurality of locations of the plurality of codewords is determined based on a plurality of lengths of the plurality of codewords.

In some embodiments, at least one byte at a beginning of a codeword of the plurality of codewords indicates a respective length of the codeword.

In some embodiments, the conversion comprises encoding the current visual unit into the bitstream.

In some embodiments, the number of the plurality of threads comprises a maximum number of threads used in entropy coding.

In some embodiments, the maximum number of threads is determined based on at least one of: a profile, or a configuration file (also referred to as a config file).

In some embodiments, the maximum number of threads is a fixed parameter.

In some embodiments, the maximum number of threads is determined based on at least one of: the number of slices, the number of tiles, the number of processing units, or a resolution of a processing unit of the visual data.

In some embodiments, performing the conversion comprises: determining at least one quantized residual representation and at least one corresponding quantized hyperprior information of the current visual unit; determining a first probability distribution of the at least one quantized residual representation and a second probability distribution of the at least one quantized hyperprior information; dividing the at least one quantized residual representation into a plurality of groups of quantized residual representations based on the number of the plurality of threads; determining a plurality of codewords based on the plurality of groups of quantized residual representations; and generating the bitstream based on the plurality of codewords. As used herein, the quantized residual representation may be quantized residual latent ŵ. The quantized hyperprior information may be referred to as \hat{z}.

In some embodiments, determining the plurality of codewords comprises: for each of the plurality of groups, creating a thread for arithmetic encoding to generate at least one codeword in the plurality of codewords. In other words, for each group, a thread is created to finish the arithmetic encoding, and generate codewords.

In some embodiments, generating the bitstream based on the plurality of codewords comprises: generating the bitstream based on a combination of the plurality of codewords. For example, all codewords may be combined by concatenation.

In some embodiments, the number of threads and location information of the plurality of codewords are included in the bitstream.

In some embodiments, the location information is included at a beginning of the bitstream.

In some embodiments, the location information comprises a plurality of location syntax elements for the plurality of codewords, a location syntax element in the plurality of location syntax element being included at a beginning in a corresponding codeword in the plurality of codewords the bitstream.

In some embodiments, at least one of the number of threads or the location information is coded by entropy coding.

In some embodiments, performing the conversion further comprises: dividing the quantized hyperprior information into a plurality of groups of quantized hyperprior information based on the number of the plurality of threads. That is, besides ŵ, hyperprior information \hat{z} may be divided into N groups.

In some embodiments, the plurality of groups of quantized hyperprior information and the plurality of groups of quantized residual representations are encoded independently with arithmetic coding to determining respective codewords. For example, the grouped ŵ and \hat{z} may be encoded independently with arithmetic coding to form their own codewords.

In some embodiments, one of the plurality of groups of quantized residual representations and a corresponding one of the plurality of groups of quantized hyperprior information are encoded together in a single codeword by arithmetic coding.

In some embodiments, the at least one quantized residual representation is divided in at least one of: a spatial domain, or a channel domain.

In some embodiments, the at least one quantized residual representation is flattened into a vector of a single dimension, and the vector is divided into the plurality of groups of quantized residual representations. That is, ŵ may be flattened into 1 dimension vector, and then evenly split into N parts.

In some embodiments, flattening of the at least one quantized residual representation comprises: scanning at least one symbol of the at least one quantized residual representation in channel dimension; and scanning symbols in spatial domain by zig-zag scan order.

In some embodiments, flattening of the at least one quantized residual representation comprises: scanning at least one symbol of the at least one quantized residual representation in spatial domain by zig-zag scan order; and scanning symbols by channel dimension.

In some embodiments, the conversion comprises decoding the current visual unit from the bitstream.

In some embodiments, determining the plurality of threads comprises: determining a maximum number of the plurality of threads from the bitstream; and determining a target number of the plurality of threads based on the maximum number and a condition of a device for the conversion, the conversion being performed based on the target number of the plurality of threads.

In some embodiments, performing the conversion comprises: reading a plurality of locations in the bitstream based on the plurality of threads; determining a probability of quantized hyperprior information; decoding the quantized hyperprior information by arithmetic coding; determining a probability of at least one quantized residual representation based on the probability of quantized hyperprior information; decoding the at least one quantized residual representation based on the plurality of codewords in parallel; and determining a reconstructed image based on the decoded quantized residual representation.

In some embodiments, the target number is 1, and the plurality of codewords is decoded in sequence.

In some embodiments, the target number is greater than 1, and the plurality of codewords is decoded in a partial parallel manner.

In some embodiments, a syntax element of an interval is included in the bitstream, and the plurality of codewords is decoded based on the interval.

In some embodiments, a byte alignment is performed at an end of a codeword in the bitstream.

In some embodiments, a bit length of the codeword is not a multiple of a predefined bit length, the byte alignment is performed at the end of the codeword by adding stuffing bits, a bit length of the aligned codeword being of a multiple of the predefined bit length.

In some embodiments, the predefined bit length is 8 bits.

In some embodiments, the byte alignment is applied to a plurality of codewords in the bitstream.

In some embodiments, at least one syntax element in the bitstream is coded by at least one of: an entropy coding, an arithmetic coding, a fixed-pattern bit string, or an exponential-Golomb coding.

In some embodiments, the at least one syntax element is coded by the arithmetic coding, and a uniform distribution is used as a probability distribution of the coded at least one syntax element.

In some embodiments, the at least one syntax element is coded by the arithmetic coding, and a probability distribution of the coded at least one syntax element is determined by a context-adaptive manner.

In some embodiments, at least one syntax element in the bitstream is coded by an unsigned or signed integer.

In some embodiments, a codeword termination is performed at at least one end of at least one codeword in a plurality of codewords in the bitstream.

In some embodiments, a codeword termination is performed at a respective end of each of a plurality of codewords in the bitstream.

According to further embodiments of the present disclosure, a non-transitory computer-readable recording medium is provided. The non-transitory computer-readable recording medium stores a bitstream of visual data which is generated by a method performed by an apparatus for visual data processing. In the method, a plurality of threads for coding residual information of a current visual unit of the visual data is determined. The bitstream is generated based on the plurality of threads.

According to still further embodiments of the present disclosure, a method for storing bitstream of visual data is provided. In the method, a plurality of threads for coding residual information of a current visual unit of the visual data is determined. The bitstream is generated based on the plurality of threads. The bitstream is stored in a non-transitory computer-readable recording medium.

Implementations of the present disclosure can be described in view of the following clauses, the features of which can be combined in any reasonable manner.

Clause 1. A method for visual data processing, comprising: determining, for a conversion between a current visual unit of visual data and a bitstream of the visual data, a plurality of threads for coding residual information of the current visual unit; and performing the conversion based on the plurality of threads.

Clause 2. The method of clause 1, wherein a plurality of codewords in the bitstream comprises a plurality of symbols by arithmetic coding in parallel, the residual information being included in the plurality of codewords.

Clause 3. The method of clause 2, wherein location information of the plurality of codewords is included in the bitstream.

Clause 4. The method of clause 3, wherein the location information is included in at least one byte at a beginning of the bitstream.

Clause 5. The method of clause 4, wherein the at least one byte comprises one of: a byte, two bytes, 4 bytes, 8 bytes or 16 bytes.

Clause 6. The method of any of clauses 3-5, wherein the location information comprises a relative offset of a codeword from an initial position in the bitstream, a starting position of the codeword is determined based on the relative offset.

Clause 7. The method of any of clauses 3-5, wherein the location information comprises a size of a codeword, a position of the codeword being determined based on the size.

Clause 8. The method of any of clauses 3-7, wherein the location information is coded by bit-endian coding.

Clause 9. The method of any of clauses 3-8, wherein a plurality of locations of the plurality of codewords is determined based on a plurality of lengths of the plurality of codewords.

Clause 10. The method of clause 9, wherein at least one byte at a beginning of a codeword of the plurality of codewords indicates a respective length of the codeword.

Clause 11. The method of any of clauses 1-10, wherein the conversion comprises encoding the current visual unit into the bitstream.

Clause 12. The method of clause 11, wherein the number of the plurality of threads comprises a maximum number of threads used in entropy coding.

Clause 13. The method of clause 12, wherein the maximum number of threads is determined based on at least one of: a profile, or a configuration file.

Clause 14. The method of clause 12, wherein the maximum number of threads is a fixed parameter.

Clause 15. The method of clause 12, wherein the maximum number of threads is determined based on at least one of: the number of slices, the number of tiles, the number of processing units, or a resolution of a processing unit of the visual data.

Clause 16. The method of any of clauses 12-15, wherein performing the conversion comprises: determining at least one quantized residual representation and at least one corresponding quantized hyperprior information of the current visual unit; determining a first probability distribution of the at least one quantized residual representation and a second probability distribution of the at least one quantized hyperprior information; dividing the at least one quantized residual representation into a plurality of groups of quantized residual representations based on the number of the plurality of threads; determining a plurality of codewords based on the plurality of groups of quantized residual representations; and generating the bitstream based on the plurality of codewords.

Clause 17. The method of clause 16, wherein determining the plurality of codewords comprises: for each of the plurality of groups, creating a thread for arithmetic encoding to generate at least one codeword in the plurality of codewords.

Clause 18. The method of clause 16 or 17, wherein generating the bitstream based on the plurality of codewords comprises: generating the bitstream based on a combination of the plurality of codewords.

Clause 19. The method of clause 18, wherein the number of threads and location information of the plurality of codewords are included in the bitstream.

Clause 20. The method of clause 19, wherein the location information is included at a beginning of the bitstream.

Clause 21. The method of clause 19, wherein the location information comprises a plurality of location syntax elements for the plurality of codewords, a location syntax element in the plurality of location syntax element being included at a beginning in a corresponding codeword in the plurality of codewords the bitstream.

Clause 22. The method of clause 19, wherein at least one of the number of threads or the location information is coded by entropy coding.

Clause 23. The method of any of clauses 16-22, wherein performing the conversion further comprises: dividing the quantized hyperprior information into a plurality of groups of quantized hyperprior information based on the number of the plurality of threads.

Clause 24. The method of clause 23, wherein the plurality of groups of quantized hyperprior information and the plurality of groups of quantized residual representations are encoded independently with arithmetic coding to determining respective codewords.

Clause 25. The method of clause 23, wherein one of the plurality of groups of quantized residual representations and a corresponding one of the plurality of groups of quantized hyperprior information are encoded together in a single codeword by arithmetic coding.

Clause 26. The method of any of clauses 16-25, wherein the at least one quantized residual representation is divided in at least one of: a spatial domain, or a channel domain.

Clause 27. The method of any of clauses 16-25, wherein the at least one quantized residual representation is flattened into a vector of a single dimension, and the vector is divided into the plurality of groups of quantized residual representations.

Clause 28. The method of clause 27, wherein flattening of the at least one quantized residual representation comprises: scanning at least one symbol of the at least one quantized residual representation in channel dimension; and scanning symbols in spatial domain by zig-zag scan order.

Clause 29. The method of clause 27, wherein flattening of the at least one quantized residual representation comprises: scanning at least one symbol of the at least one quantized residual representation in spatial domain by zig-zag scan order; and scanning symbols by channel dimension.

Clause 30. The method of any of clauses 1-10, wherein the conversion comprises decoding the current visual unit from the bitstream.

Clause 31. The method of clause 30, wherein determining the plurality of threads comprises: determining a maximum number of the plurality of threads from the bitstream; and determining a target number of the plurality of threads based on the maximum number and a condition of a device for the conversion, the conversion being performed based on the target number of the plurality of threads.

Clause 32. The method of clause 31, wherein performing the conversion comprises: reading a plurality of locations in the bitstream based on the plurality of threads; determining a probability of quantized hyperprior information; decoding the quantized hyperprior information by arithmetic coding; determining a probability of at least one quantized residual representation based on the probability of quantized hyperprior information; decoding the at least one quantized residual representation based on the plurality of codewords in parallel; and determining a reconstructed image based on the decoded quantized residual representation.

Clause 33. The method of clause 31 or 32, wherein the target number is 1, and the plurality of codewords is decoded in sequence.

Clause 34. The method of clause 31 or 32, wherein the target number is greater than 1, and the plurality of codewords is decoded in a partial parallel manner.

Clause 35. The method of clause 34, wherein a syntax element of an interval is included in the bitstream, and the plurality of codewords is decoded based on the interval.

Clause 36. The method of any of clauses 1-35, wherein a byte alignment is performed at an end of a codeword in the bitstream.

Clause 37. The method of clause 36, wherein a bit length of the codeword is not a multiple of a predefined bit length, the byte alignment is performed at the end of the codeword by adding stuffing bits, a bit length of the aligned codeword being of a multiple of the predefined bit length.

Clause 38. The method of clause 37, wherein the predefined bit length is 8 bits.

Clause 39. The method of any of clauses 36-38, wherein the byte alignment is applied to a plurality of codewords in the bitstream.

Clause 40. The method of any of clauses 1-39, wherein at least one syntax element in the bitstream is coded by at least one of: an entropy coding, an arithmetic coding, a fixed-pattern bit string, or an exponential-Golomb coding.

Clause 41. The method of clause 40, wherein the at least one syntax element is coded by the arithmetic coding, and a uniform distribution is used as a probability distribution of the coded at least one syntax element.

Clause 42. The method of clause 40, wherein the at least one syntax element is coded by the arithmetic coding, and a probability distribution of the coded at least one syntax element is determined by a context-adaptive manner.

Clause 43. The method of any of clauses 1-42, wherein at least one syntax element in the bitstream is coded by an unsigned or signed integer.

Clause 44. The method of any of clauses 1-43, wherein a codeword termination is performed at at least one end of at least one codeword in a plurality of codewords in the bitstream.

Clause 45. The method of any of clauses 1-43, wherein a codeword termination is performed at a respective end of each of a plurality of codewords in the bitstream.

Clause 46. An apparatus for visual data processing comprising a processor and a non-transitory memory with instructions thereon, wherein the instructions upon execution by the processor, cause the processor to perform a method in accordance with any of clauses 1-45.

Clause 47. A non-transitory computer-readable storage medium storing instructions that cause a processor to perform a method in accordance with any of clauses 1-45.

Clause 48. A non-transitory computer-readable recording medium storing a bitstream of visual data which is generated by a method performed by an apparatus for visual data processing, wherein the method comprises: determining a plurality of threads for coding residual information of a current visual unit of the visual data; and generating the bitstream based on the plurality of threads.

Clause 49. A method for storing a bitstream of visual data, comprising: determining a plurality of threads for coding residual information of a current visual unit of the visual data; generating the bitstream based on the plurality of threads; and storing the bitstream in a non-transitory computer-readable recording medium.

### Example Device

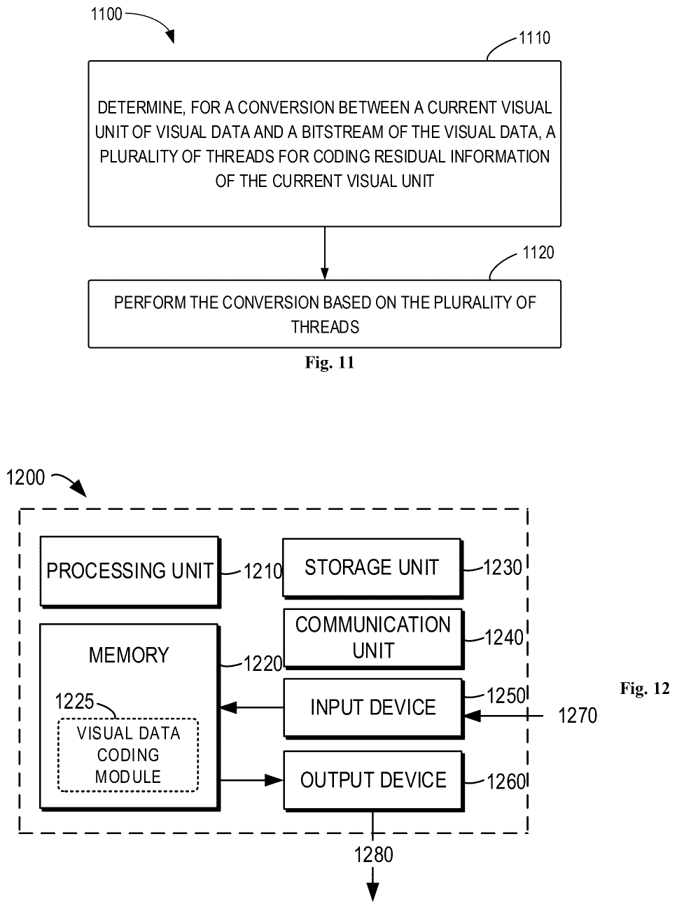

FIG. 12 illustrates a block diagram of a computing device 1200 in which various embodiments of the present disclosure can be implemented. The computing device 1200 may be implemented as or included in the source device 110 (or the data encoder 114) or the destination device 120 (or the data decoder 124).

It would be appreciated that the computing device 1200 shown in FIG. 12 is merely for purpose of illustration, without suggesting any limitation to the functions and scopes of the embodiments of the present disclosure in any manner.

As shown in FIG. 12, the computing device 1200 includes a general-purpose computing device 1200. The computing device 1200 may at least comprise one or more processors or processing units 1210, a memory 1220, a storage unit 1230, one or more communication units 1240, one or more input devices 1250, and one or more output devices 1260.

In some embodiments, the computing device 1200 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1200 can support any type of interface to a user (such as “wearable” circuitry and the like).

The processing unit 1210 may be a physical or virtual processor and can implement various processes based on programs stored in the memory 1220. In a multi-processor system, multiple processing units execute computer executable instructions in parallel so as to improve the parallel processing capability of the computing device 1200. The processing unit 1210 may also be referred to as a central processing unit (CPU), a microprocessor, a controller or a microcontroller.

The computing device 1200 typically includes various computer storage medium. Such medium can be any medium accessible by the computing device 1200, including, but not limited to, volatile and non-volatile medium, or detachable and non-detachable medium. The memory 1220 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1230 may be any detachable or non-detachable medium and may include a machine-readable medium such as a memory, flash memory drive, magnetic disk or another other media, which can be used for storing information and/or data and can be accessed in the computing device 1200.

The computing device 1200 may further include additional detachable/non-detachable, volatile/non-volatile memory medium. Although not shown in FIG. 12, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1240 communicates with a further computing device via the communication medium. In addition, the functions of the components in the computing device 1200 can be implemented by a single computing cluster or multiple computing machines that can communicate via communication connections. Therefore, the computing device 1200 can operate in a networked environment using a logical connection with one or more other servers, networked personal computers (PCs) or further general network nodes.

The input device 1250 may be one or more of a variety of input devices, such as a mouse, keyboard, tracking ball, voice-input device, and the like. The output device 1260 may be one or more of a variety of output devices, such as a display, loudspeaker, printer, and the like. By means of the communication unit 1240, the computing device 1200 can further communicate with one or more external devices (not shown) such as the storage devices and display device, with one or more devices enabling the user to interact with the computing device 1200, or any devices (such as a network card, a modem and the like) enabling the computing device 1200 to communicate with one or more other computing devices, if required. Such communication can be performed via input/output (I/O) interfaces (not shown).

In some embodiments, instead of being integrated in a single device, some or all components of the computing device 1200 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1200 may be used to implement visual data encoding/decoding in embodiments of the present disclosure. The memory 1220 may include one or more visual data coding modules 1225 having one or more program instructions. These modules are accessible and executable by the processing unit 1210 to perform the functionalities of the various embodiments described herein.

In the example embodiments of performing visual data encoding, the input device 1250 may receive visual data as an input 1270 to be encoded. The visual data may be processed, for example, by the visual data coding module 1225, to generate an encoded bitstream. The encoded bitstream may be provided via the output device 1260 as an output 1280.

In the example embodiments of performing visual data decoding, the input device 1250 may receive an encoded bitstream as the input 1270. The encoded bitstream may be processed, for example, by the visual data coding module 1225, to generate decoded visual data. The decoded visual data may be provided via the output device 1260 as the output 1280.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

What is claimed is:

1. A method for visual data processing, comprising:
determining, for a conversion between a current visual unit of visual data and a bitstream of the visual data, a plurality of threads for coding residual information of the current visual unit; and
performing the conversion based on the plurality of threads.

2. The method of claim 1, wherein a plurality of codewords in the bitstream comprises a plurality of symbols by arithmetic coding in parallel, the residual information being included in the plurality of codewords.

3. The method of claim 2, wherein location information of the plurality of codewords is included in the bitstream, wherein the location information is included in at least one byte at a beginning of the bitstream,
wherein the location information comprises a relative offset of a codeword from an initial position in the bitstream, a starting position of the codeword is determined based on the relative offset, or
wherein the location information comprises a size of a codeword, a position of the codeword being determined based on the size.

4. The method of claim 1, wherein the conversion comprises encoding the current visual unit into the bitstream.

5. The method of claim 4, wherein the number of the plurality of threads comprises a maximum number of threads used in entropy coding.

6. The method of claim 5, wherein the maximum number of threads is determined based on at least one of: a profile, or a configuration file, or
wherein the maximum number of threads is a fixed parameter, or
wherein the maximum number of threads is determined based on at least one of: the number of slices, the number of tiles, the number of processing units, or a resolution of a processing unit of the visual data.

7. The method of claim 5, wherein performing the conversion comprises:
determining at least one quantized residual representation and at least one corresponding quantized hyperprior information of the current visual unit;
determining a first probability distribution of the at least one quantized residual representation and a second probability distribution of the at least one quantized hyperprior information;
dividing the at least one quantized residual representation into a plurality of groups of quantized residual representations based on the number of the plurality of threads;
determining a plurality of codewords based on the plurality of groups of quantized residual representations; and
generating the bitstream based on the plurality of codewords.

8. The method of claim 7, wherein determining the plurality of codewords comprises:
for each of the plurality of groups, creating a thread for arithmetic encoding to generate at least one codeword in the plurality of codewords.

9. The method of claim 7, wherein generating the bitstream based on the plurality of codewords comprises:
generating the bitstream based on a combination of the plurality of codewords,
wherein the number of threads and location information of the plurality of codewords are included in the bitstream,
wherein the location information is included at a beginning of the bitstream, or
wherein the location information comprises a plurality of location syntax elements for the plurality of codewords, a location syntax element in the plurality of location syntax element being included at a beginning in a corresponding codeword in the plurality of codewords the bitstream, and/or
wherein at least one of the number of threads or the location information is coded by entropy coding.

10. The method of claim 7, wherein performing the conversion further comprises:
dividing the quantized hyperprior information into a plurality of groups of quantized hyperprior information based on the number of the plurality of threads.

11. The method of claim 10, wherein the plurality of groups of quantized hyperprior information and the plurality of groups of quantized residual representations are encoded independently with arithmetic coding to determining respective codewords, or
wherein one of the plurality of groups of quantized residual representations and a corresponding one of the plurality of groups of quantized hyperprior information are encoded together in a single codeword by arithmetic coding.

12. The method of claim 7, wherein the at least one quantized residual representation is divided in at least one of: a spatial domain, or a channel domain, or
wherein the at least one quantized residual representation is flattened into a vector of a single dimension, and the vector is divided into the plurality of groups of quantized residual representations.

13. The method of claim 1, wherein the conversion comprises decoding the current visual unit from the bitstream.

14. The method of claim 13, wherein determining the plurality of threads comprises:
determining a maximum number of the plurality of threads from the bitstream; and
determining a target number of the plurality of threads based on the maximum number and a condition of a device for the conversion, the conversion being performed based on the target number of the plurality of threads.

15. The method of claim 14, wherein performing the conversion comprises:
reading a plurality of locations in the bitstream based on the plurality of threads;
determining a probability of quantized hyperprior information;
decoding the quantized hyperprior information by arithmetic coding;
determining a probability of at least one quantized residual representation based on the probability of quantized hyperprior information;
decoding the at least one quantized residual representation based on the plurality of codewords in parallel; and
determining a reconstructed image based on the decoded quantized residual representation.

16. The method of claim 15, wherein the target number is 1, and the plurality of codewords is decoded in sequence, or
wherein the target number is greater than 1, and the plurality of codewords is decoded in a partial parallel manner, wherein a syntax element of a interval is included in the bitstream, and the plurality of codewords is decoded based on the interval.

17. The method of claim 1, wherein a byte alignment is performed at an end of a codeword in the bitstream,
wherein a bit length of the codeword is not a multiple of a predefined bit length, the byte alignment is performed at the end of the codeword by adding stuffing bits, a bit length of the aligned codeword being of a multiple of the predefined bit length, wherein the predefined bit length is 8 bits, and/or
wherein the byte alignment is applied to a plurality of codewords in the bitstream.

18. An apparatus for visual data processing comprising a processor and a non-transitory memory with instructions thereon, wherein the instructions upon execution by the processor, cause the processor to:
determine, for a conversion between a current visual unit of visual data and a bitstream of the visual data, a plurality of threads for coding residual information of the current visual unit; and
perform the conversion based on the plurality of threads.

19. A non-transitory computer-readable storage medium storing instructions that cause a processor to perform acts comprising:
determining, for a conversion between a current visual unit of visual data and a bitstream of the visual data, a plurality of threads for coding residual information of the current visual unit; and
performing the conversion based on the plurality of threads.

20. A non-transitory computer-readable recording medium storing a bitstream of visual data which is generated by a method performed by an apparatus for visual data processing, wherein the method comprises:
determining a plurality of threads for coding residual information of a current visual unit of the visual data; and
generating the bitstream based on the plurality of threads.
